(19) United States
(12) Patent Application Publication
(10) Pub. No.: US 2018/0053945 A1
(43) Pub. Date: Feb. 22, 2018

(54) METAL-AIR BATTERY AND METHOD FOR PRODUCING SAME

(71) Applicant: Fujikura Rubber Ltd., Tokyo (JP)

(72) Inventors: Tsutomu Narita, Saitama (JP); Masahiro Seshimo, Saitama (JP); Hirokuni Ota, Saitama (JP); Hiroshi Sakama, Saitama (JP)

(73) Assignee: Japan Lifeline Co., Ltd.

(21) Appl. No.: 15/784,942

(22) Filed: Oct. 16, 2017

Related U.S. Application Data
(63) Continuation of application No. PCT/JP2016/063934, filed on May 10, 2016.

(30) Foreign Application Priority Data
May 21, 2015 (JP) 2015-103689

(51) Int. Cl. H01M 4/86; H01M 12/06; H01M 4/88; H01M 4/46

(52) U.S. Cl. CPC H01M 4/8626; H01M 12/06; H01M 4/466; H01M 4/8828; H01M 4/8621

(57) ABSTRACT

An object of the present invention is to provide a metal-air battery capable of achieving high enough output (maximum power) to be applicable to use such as charging a cell phone. The metal-air battery of the present invention uses a metal as an active material of a negative electrode 30 and oxygen in the air as an active material of a positive electrode 20. The positive electrode 20 comprises a current collector 21 composed of a plate-like porous metal material and a conductive material layer 23 disposed on one surface side of the current collector 21. At least one surface of the current collector 21 on which the conductive material layer 23 is disposed is coated with a conductive coating material to form a coating conductive film 25.

This is a continuation of International Application No. PCT/JP2016/063934 filed May 10, 2016 which claims the foregin filing benefit based on Japanese Patent Application No. 2015-103689 filed May 21, 2015, the entire contents of which are incorporated herein by reference.

### TECHNICAL FIELD

The present invention relates to a metal-air battery that uses a metal as an active material of a negative electrode and oxygen in the air as an active material of a positive electrode.

### BACKGROUND ART

Conventionally, metal-air batteries (magnesium-air batteries) that use magnesium or a magnesium alloy as an active material of a negative electrode and air as an active material of a positive electrode have been proposed (see, for example, PTL 1 and PTL 2 below).

PTL 1 describes a positive electrode (cathode body) of a metal-air battery formed by laminating a plate-like current collector layer formed from a conductive metal, an active layer formed from a positive electrode active material such as activated carbon, and an electrode layer formed of a conductive material such as a carbon material. The same document describes a porous material as a preferable current collector layer.

PTL 2 describes a positive electrode (air electrode body) of a metal-air battery formed by coating a current collector composed of foamed nickel with a conductive material slurry, and afterwards firing it. This conductive material slurry is prepared by depositing platinum on a conductive material, putting them into an aqueous dispersion of PTFE, and stirring and mixing them.

### CITATION LIST

### Patent Literature

PTL 1: Japanese Unexamined Patent Application Publication No. 2014-120401.

PTL 2: Japanese Unexamined Patent Application Publication No. 2013-191481.

### SUMMARY OF INVENTION

### Technical Problem

Metal-air batteries used for, for example, charging a cell phone, is desired to have a certain degree of high output (maximum power).

However, the metal-air batteries described in PTL 1 and PTL 2 have high internal resistance, and they cannot obtain sufficiently high output.

The present invention has been made in view of the above circumstances. An object of the present invention is to provide a metal-air battery capable of achieving high enough output (maximum power) to be applicable to use such as charging a cell phone.

### Solution to Problem

As a result of intensive studies made by the present inventors to achieve the above object, it has been found that on a positive electrode formed by laminating a current collector composed of a porous metal material and a conductive material layer, interposing a coating film of a conductive coating material between the current collector and the conductive material layer reduces a contact resistance between them to allow an internal resistance to be low, and thus it enables to improve the output. Based on these findings, the present invention has been completed.

A metal-air battery of the present invention uses a metal as an active material of a negative electrode and oxygen in the air as an active material of a positive electrode. The positive electrode comprises a current collector composed of a plate-like porous metal material and a conductive material layer disposed on one surface side of the current collector. At least one surface of the current collector on which the conductive material layer is disposed is coated with a conductive coating material.

In the metal-air battery of the present invention, it is preferable that the porous metal material composing the current collector is a metal foam.

In the metal-air battery of the present invention, it is preferable that a volume resistivity value of a dried coating film of the conductive coating material is 1.0 Ωcm or less, and particularly between 5.0×10⁻³ and 4.0×10⁻¹ Ωcm.

In the metal-air battery of the present invention, it is preferable that a coating amount of the conductive coating material is between 2 and 10 mg/cm².

In the metal-air battery of the present invention, it is preferable that the active material of the negative electrode is magnesium or a magnesium alloy.

A method of manufacturing a metal-air battery of the present invention is a method of manufacturing a metal-air battery that uses a metal as an active material of a negative electrode and oxygen in the air as an active material of a positive electrode,

comprising a step of producing the positive electrode by coating at least one surface of a current collector composed of a plate-like porous metal material with a conductive coating material and disposing a conductive material layer on one surface side of the current collector coated with the conductive coating material.

### Advantageous Effects of Invention

The metal-air battery of the present invention has a low internal resistance and can achieve a high output (maximum power), as is apparent from the result of the below-mentioned Examples.

### BRIEF DESCRIPTION OF DRAWINGS

FIG. 1 is an explanation view schematically showing a general structure of a metal-air battery of the present invention.

### DESCRIPTION OF EMBODIMENTS

A magnesium-air battery according to one embodiment of a metal-air battery of the present invention will now be described in detail.

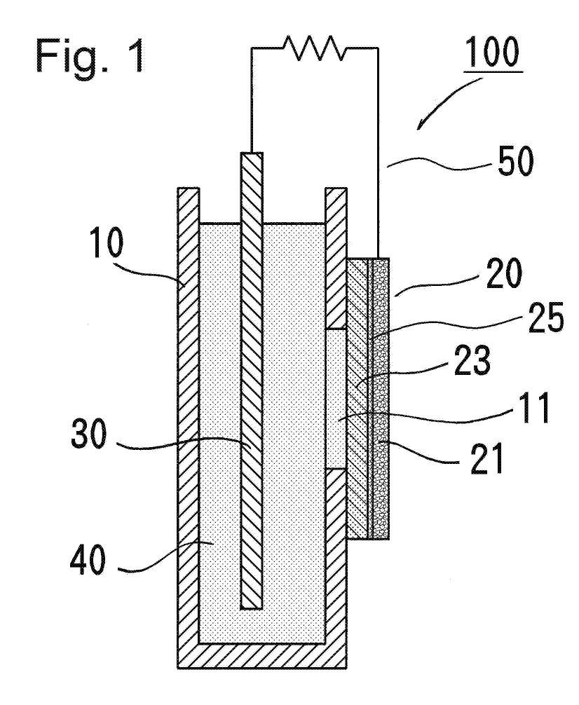

A magnesium-air battery 100 of this embodiment shown in FIG. 1 comprises a bottomed rectangular cylindrical container 10, a plate-like positive electrode 20 being an air electrode fixedly positioned at a side wall of this container 10, and a plate-like negative electrode 30 positioned opposite to the positive electrode 20 in the container 10.

The container 10 composing the magnesium-air battery 100 is composed of a bottomed rectangular cylindrical resin, and this container contains, for example, salt solution as an electrolyte solution 40.

An opening window 11 is formed on the side wall composing the container 10, and the plate-like positive electrode 20 is fixed at the side wall of the container 10 so as to cover the opening window 11.

The positive electrode 20 being the air electrode of the magnesium-air battery 100 comprises a current collector and a conductive material layer 23 disposed on one surface side of this current collector 21. The current collector 21 of the positive electrode 20 has a lead 50 connected through a terminal not shown.

The current collector 21 of the positive electrode 20 is an outer layer contacting with air, and composed of a plate-like porous metal material. Examples of the porous metal materials composing the current collector 21 include a metal foam and a sintered body of metal powder. Among them, the metal foam is preferable.

Examples of the metals composing the current collector 21 (porous metal material) include nickel, copper and stainless steel (SUS).

The porous metal material is used as the current collector 21, and this brings high binding capacity between the current collector 21 and the conductive material layer 23 by the anchor effect.

The metal foam being a preferable porous metal material can be produced by metal-plating a urethane foam in an open-cell type, and afterwards heating it in an oxidizing atmosphere and in a reducing atmosphere to burn (eliminate) the urethane.

Examples of preferable marketed metal foams include “Celmet” (manufactured by Sumitomo Electric Industries, Ltd.).

The conductive material layer 23 of the positive electrode 20 is an inner layer contacting with the electrolyte solution 40 (salt solution) contained in the container 10.

This conductive material layer 23 is formed by binding a conductive material with a binder resin.

The conductive material used to obtain the conductive material layer 23 is not limited to a particular material. All the materials composing a conventionally known positive electrode (conductive material layer) of a metal-air battery can be used. Examples of preferable conductive materials include carbon materials such as acetylene black, Ketjenblack, activated carbon and carbon nanotube.

The binder resin mixed with the conductive material to form the conductive material layer 23 of the positive electrode 20 is not limited to a particular resin. Examples of preferable binder resins include fluorine resin such as polyvinylidene fluoride (PVDF), polytetrafluoroethylene (PTFE), tetrafluoroethylene-hexafluoropropylene copolymer (FEP), tetrafluoroethylene-perfluoroalkylvinylether copolymer (PFA), ethylene-tetrafluoroethylene copolymer (ETFE), polychlorotrifluoroethylene (PCTFE), ethylene-chlorotrifluoroethylene copolymer (ECTFE) and polyvinyl fluoride (PVF).

The conductive material layer 23 may contain a conventionally known electrode catalyst for a positive electrode of an air battery.

Examples of catalysts capable of being contained in the conductive material layer 23 include metals such as platinum (Pt), ruthenium (Ru), iridium (Ir), rhodium (Rh), palladium (Pd), osmium (Os), tungsten (W), lead (Pb), iron (Fe), chromium (Cr), cobalt (Co), nickel (Ni), manganese (Mn), vanadium (V), molybdenum (Mo), gallium (Ga) and aluminum (Al), and compounds thereof, and alloys thereof.

In the magnesium-air battery 100, one surface of the current collector 21 of the positive electrode 20 (the surface on which the conductive material layer 23 is disposed) is coated with a conductive coating material to form a conductive coating film 25. The “coating film” may be an impregnated layer of the conductive coating material in the inside of the current collector 21 (porous metal material).

The conductive coating film 25 is formed on one surface of the current collector 21 on which the conductive material layer 23 is disposed. This reduces a contact resistance between the current collector 21 and the conductive material layer 23 to allow an internal resistance of the battery to be low. It enables to improve the output (maximum power) compared to the case where such a coating film is not formed.

As for the conductive coating material coated on one surface of the current collector 21, a known coating material containing conductive particles, a binder and a solvent can be used, and it may be a water-soluble type or may be an organic solvent type.

Examples of the conductive particles contained in the conductive coating material include carbon particles such as carbon black and graphite, and metal particles.

Examples of the binders contained in the conductive coating material of water soluble type include a cellulose resin, a water glass and an acrylic resin. Examples of the solvents include water.

Examples of the binders contained in the conductive coating material of organic solvent type include thermoplastic resin, a vinyl resin and a synthetic rubber. Examples of the solvents include various organic solvents.

The coating method of the conductive coating material is not limited to a particular method. Examples thereof include coating with a brush or a roller, spray coating and dip coating.

A volume resistivity value of the conductive coating film 25 (dried coating film) formed with the conductive coating material is usually 1.0 Ωcm or less, and preferably between 5.0×10⁻³ and 4.0×10⁻¹ Ωcm.

The conductive coating material with excessive volume resistivity value of coating film cannot sufficiently reduce the contact resistance between the current collector and the conductive material layer.

A coating amount of the conductive coating material (formation amount of the dried coating film) is preferably between 2 and 10 mg/cm².

A battery with the coating amount of less than 2 mg/cm² cannot achieve the reduction effect of the internal resistance (contact resistance between the current collector 21 and the conductive material layer 23) and the improvement effect of the output.

Conversely, a battery having more than 10 mg/cm² of the conductive caoting material cannot get the effect appropriate to the coating amount.

The negative electrode 30 composing the magnesium-air battery 100 is in a plate form and positioned opposite to the positive electrode 20 in the container 10. This negative electrode 30 has a lead 50 connected through a terminal not shown.

The negative electrode 30 (negative electrode active material) is a metal electrode composed of magnesium or a magnesium alloy.

As for a magnesium alloy composing the negative electrode 30, all the materials composing a conventionally known negative electrode body of a magnesium-air battery can be used.

Specifically, the alloy may include at least one metal selected from aluminum, zinc, manganese, silicon, rare-earth element, calcium, strontium, tin, germanium, lithium, zirconium and beryllium, and magnesium.

Examples of preferable magnesium alloys include an alloy containing magnesium, aluminum and zinc such as AZ31, AZ61 and AZ91, an alloy containing magnesium, aluminum and manganese such as AM60 and AM80, and an alloy containing magnesium, lithium and zinc such as LZ91.

In the magnesium-air battery 100 of this embodiment, the oxidation reaction shown below (1) occurs on the negative electrode 30, the reduction reaction shown below (2) occurs on the positive electrode 20, and for the battery as a whole, the reaction shown below (3) occurs. Then, electricity is discharged.

2Mg→2Mg⁺+4e⁻

O₂+2H₂O+4e⁻→4OH⁻

2Mg+O₂+2H₂O→2Mg(OH)₂

In the magnesium-air battery 100 of this embodiment, one surface of the current collector 21 is coated with the conductive coating material to interpose the conductive coating film 25 between the current collector 21 and the conductive material layer 23. This reduces the contact resistance between the current collector 21 and the conductive material layer 23 to allow the internal resistance of the battery to be low. It enables to achieve a high output (maximum power at a current-voltage characteristics test) compared to the case where such a coating film is not formed, as is apparent from the result of the below-mentioned Examples.

Although an embodiment of the present invention has been described, the metal-air battery of the present invention is not limited to this, and various changes may be made.

For example, the metal composing the negative electrode is not limited to magnesium or a magnesium alloy, and all the metal materials composing a conventionally known negative electrode (metal electrode) of a metal-air battery can be used.

Specifically, zinc, lithium, iron, sodium, beryllium, aluminum, cadmium and lead, and alloys thereof can be used.

Both surfaces of the current collector may be coated with the conductive coating material.

The metal-air battery of the present invention can be preferably used for charging a cell phone and for driving low power electric appliances.

### EXAMPLES

Hereinafter, examples of the present invention will be described, but the present invention is not limited to these examples. In the examples below, a volume resistivity value of a dried coating film of a conductive coating material was determined as follows.

(Measurement Method of a Volume Resistivity Value)

A dried coating film was formed by coating a conductive coating material 2 g on a glass plate with a doctor blade, and heated and dried it. Then, the dried coating film was cut into a piece of 30 mm×60 mm. With a distance of 50 mm between measurement terminals, each terminal was subjected to a load of 500 g, a resistance value of a sample (dried coating film) was measured to determine a sheet resistivity value (area resistance value), and with a micrometer, a film thickness was measured to determine a volume resistivity value.

### Example 1

A water-soluble type conductive coating material “Varniphite T-602”, as described below in detail, was mixed with deionized water in a ratio of 1:1 (mass ratio). The obtained mixed solution was coated with a brush on one surface of a current collector (60 mm×80 mm×1.4 mm) composed of a porous metal material “Celmet #8” (manufactured by Sumitomo Electric Industries, Ltd.) composed of foamed nickel, and it was dried in a constant temperature bath at 100° c. for one hour to form a conductive coating film on one surface of the current collector. A coating amount (formation amount of a dried coating film) was 2.2 mg/cm². On one surface of the current collector after forming the coating film, the same porous surface condition was maintained as before coating.

(Varniphite T-602)

water soluble type conductive coating material manufactured by Nippon Graphite Industries, Co., Ltd.

solid content: 27%

particle size of graphite (conductive particle): 38 μm

viscosity: 450 mPa s

volume resistivity value: 1.8×10⁻² Ωcm binder: cellulose-based

Next, a conductive material in a sheet form (60 mm×60 mm×0.5 mm) containing Ketjenblack (conductive material) 100 parts by mass, manganese dioxide (catalyst) 25 parts by mass and PTFE (binder resin) 100 parts by mass was bonded on one surface of the current collector having the conductive coating film formed on, and it was press-bonded with a press machine to produce a positive electrode (60 mm×80 mm×1 mm) having the current collector and a conductive material layer bonded on one surface side of this current collector through the conductive coating film.

After that, an opening window of 40 mm×40 mm was formed on a side wall composing one side surface of a bottomed rectangular cylindrical container having a size of 100 mm×100 mm×25 mm. By abutting the positive electrode against the side wall so as to close this opening window liquid-tightly from the outside of the container, the positive electrode was fixed.

The positive electrode was fixed so that the conductive material layer composing the positive electrode became an inner part (electrolyte side) and the current collector became an outer part (air side). A copper plate holding one end of this positive electrode was considered to be a positive terminal.

Meanwhile, a plate-like negative electrode (30 mm×150 mm×0.5 mm) composed of a magnesium alloy “AZ31B” was positioned opposite to the positive electrode in the container. A copper plate holding one end of this negative electrode was considered to be a negative terminal.

Then, as an electrolyte, salt solution 200 mL with a concentration of 10% was supplied into the container to produce a metal-air battery of the present invention having a configuration shown in FIG. 1.

### Example 2

A metal-air battery of the present invention was produced as in Example 1 except changing the conductive coating material into “Varniphite T-602U” described below in detail.

(Varniphite T-602U)

water soluble type conductive coating material manufactured by Nippon Graphite Industries, Co., Ltd.

solid content: 20%

particle size of graphite (conductive particle): 15 μm

viscosity: 125 mPa s

volume resistivity value: 5.0×10⁻³ Ωcm

binder: cellulose-based

### Example 3

A metal-air battery of the present invention was produced as in Example 1 except changing the conductive coating material into “Varniphite #525” described below in detail.

(Varniphite #525)

water soluble type conductive coating material manufactured by Nippon Graphite Industries, Co., Ltd.

solid content: 27%

particle size of graphite (conductive particle): 6 μm

viscosity: 575 mPa s

volume resistivity value: 1.2×10⁻¹ Ωcm

binder: acryl-based

### Example 4

A metal-air battery of the present invention was produced as in Example 1 except that a mixed solution comprising a conductive coating material “Varniphite UCC-2” described below in detail and MEK in a ratio of 1:1 was coated on one surface of a current collector.

(Varniphite UCC-2)

organic solvent type conductive coating material manufactured by Nippon Graphite Industries, Co., Ltd.

solid content: 19%

particle size of graphite (conductive particle): 10 μm

viscosity: 0.37 mPa s

volume resistivity value: 6.0×10⁻³ Ωcm

binder: rubber-based

solvent: xylene, toluene

### Example 5

A metal-air battery of the present invention was produced as in Example 1 except that a mixed solution comprising a conductive coating material “Varniphite #27” described below in detail and MEK in a ratio of 1:1 was coated on one surface of a current collector.

(Varniphite #27)

organic solvent type conductive coating material manufactured by Nippon Graphite Industries, Co., Ltd.

solid content: 32%

particle size of graphite (conductive particle): 6 μm

viscosity: 0.5 mPa s

volume resistivity value: 4.0×10⁻¹ Ωcm

binder: vinyl-based

solvent: ketone-based

### Comparative Example 1

A metal-air battery for comparison was produced as in Example 1 except that a conductive coating material was not coated (a conductive coating film was not formed) on one surface of a current collector.

### Test Example 1

### Output Performance

As for each metal-air battery obtained from Example 1 to Example 5 and Comparative Example 1, a current-voltage (I-V) characteristics test was performed. A current density at short-circuit, a maximum power density and an internal resistance were measured. Table 1 below shows the results.

For current-voltage control, using an electronic load device “PLZ664WA” (manufactured by Kikusui Electronics Corporation), the positive terminal and the negative terminal of the metal-air battery were respectively connected onto a positive side terminal and a negative side terminal of the electronic load device. At a constant current mode, a set current value was increased from OA to 5A for 300 minutes (when the set current value was not increased to 5A, the test was finished at that time).

TABLE 1

| | Example | Example | Example | Example | Example | Comparative |
|---|---|---|---|---|---|---|
| | 1 | 2 | 3 | 4 | 5 | Example 1 |
| conductive | T-602 | T-602U | #525 | UCC-2 | #27 | none |
| coating | | | | | | |
| material | | | | | | |
| volume | 1.8 × 10⁻² | 5.0 × 10⁻³ | 1.2 × 10⁻¹ | 6.0 × 10⁻³ | 4.0 × 10⁻¹ | |
| resistivity | | | | | | |
| value [Ω cm] | | | | | | |
| current | 246 | 250 | 243 | 229 | 241 | 169 |
| density at | | | | | | |
| short-circuit | | | | | | |
| [mA/cm²] | | | | | | |
| maximum | 76 | 79 | 78 | 71 | 71 | 51 |
| power density | | | | | | |
| [mW/cm²] | | | | | | |
| internal | 0.33 | 0.33 | 0.33 | 0.34 | 0.33 | 0.48 |
| resistance [Ω] | | | | | | |

As shown in Table 1, the metal-air batteries obtained from Example 1 to Example 5 have a high current density at short-circuit, a high maximum power density and a low internal resistance compared to the metal-air battery obtained from Comparative Example 1.

### REFERENCE SIGNS LIST

100 magnesium-air battery

10 container

11 opening window

20 positive electrode

21 conductive material layer

23 current collector

25 conductive coating film

30 negative electrode

40 electrolyte solution

50 lead

1. A metal-air battery using a metal as an active material of a negative electrode and oxygen in the air as an active material of a positive electrode,
wherein the positive electrode comprises a current collector composed of a plate-like porous metal material and a conductive material layer disposed on one surface side of the current collector, and
at least one surface of the current collector on which the conductive material layer is disposed is coated with a conductive coating material.

2. The metal-air battery according to claim 1, wherein the porous metal material composing the current collector is a metal foam.

3. The metal-air battery according to claim 1, wherein a volume resistivity value of a dried coating film of the conductive coating material is 1.0 Ωcm or less.

4. The metal-air battery according to claim 1, wherein a volume resistivity value of a dried coating film of the conductive coating material is between 5.0×10⁻³ and 4.0×10⁻¹ Ωcm.

5. The metal-air battery according to claim 1, wherein a coating amount of the conductive coating material is between 2 and 10 mg/cm².

6. The metal-air battery according to claim 1, wherein the active material of the negative electrode is magnesium or a magnesium alloy.

7. A method of manufacturing a metal-air battery using a metal as an active material of a negative electrode and oxygen in the air as an active material of a positive electrode,
comprising a step of producing the positive electrode by coating at least one surface of a current collector composed of a plate-like porous metal material with a conductive coating material and disposing a conductive material layer on one surface side of the current collector coated with the conductive coating material.
